(19) United States
(12) Patent Application Publication
(10) Pub. No.: US 2004/0260599 A1
(43) Pub. Date: Dec. 23, 2004

(54) System and methods for estimating product sales in highly fragmented geographically segments of service provider location

(76) Inventors: Stefan Ziegele, Neu-Anspach (DE); Andreas Gieshoff, Niedernhausen (DE)

Correspondence Address: BAKER & BOTTS, 30 ROCKEFELLER PLAZA, NEW YORK, NY, 10112

(21) Appl. No.: 10/476,197

(22) PCT Filed: Apr. 24, 2002
(86) PCT No.: PCT/US02/12759

Related U.S. Application Data
(60) Provisional application No. 60/288,913, filed on May 4, 2001.

(51) Int. Cl. G06F 17/60

(52) U.S. Cl. 705/10

(57) ABSTRACT

An object of the present invention is to provide a technique of combining census data on related, but not identical, variables in order to enhance the value of sampled data.

### BACKGROUND OF THE INVENTION

This invention relates to systems and statistical methods for estimating product sales based on data received from several sources, including census data and sampled data.

The process of collecting information on pharmaceutical sales may be complicated by the fragmentary manner in which data is collected for different sales transactions. Such pharmaceutical sales transactions may fall into several categories. For example, pharmaceutical products may be sold by a manufacturer to a wholesaler, who in turn in turn sells such products to retail pharmacies. Alternatively, pharmaceutical products may be sold by manufacturers directly to retail pharmacies with no wholesaler interaction. Such transactions are referred to as “direct sales.”

From the retail pharmacy, pharmaceutical products may be sold to patients covered under private health insurance, also referred to as “PKV prescriptions.” Pharmaceutical products may alternatively be sold to patients covered by public health insurance, also referred to as “GKV prescriptions.” Patients may also purchase pharmaceutical products from retail pharmacies without any insurance reimbursement. Pharmaceutical product sales may fall into other categories as well.

Pharmaceutical sales data may be allocated into geographical subsections in order to evaluate such data. For example, a geographical region in Germany may be divided into smaller geographical segments, often referred to as “bricks.” Records of the pharmaceutical sales may indicate the geographical subsection corresponding to the location of the sales, such as the dispensing pharmacy location or “pharmacy brick,” or indicate the geographical subsection corresponding to the location of the prescribing physician, or “prescriber brick.” However, currently available data records generally do not indicate both the location of the dispensing pharmacy and the location of the prescriber in the same data record. Other countries use similar geographical subdivision schema

In principle, there are several methods for collecting information about sales related to private insurance prescriptions on the level of small geographical segments, or “prescriber bricks.” Usually, the geographical segments are relatively small; therefore, a near-census data collection is required in order to achieve an acceptably high accuracy level. These methods involve considerable costs and the associated problems of achieving census data.

One proposed method of data collection is a census of pharmaceutical sales by pharmacy location, prescriber location, and product. “Census” information, as understood herein and well-known in the art, refers to gathering information from an entire population of interest. Census information does not require any projections to compensate for missing segments of the population of interest. Census information at the lowest geographical level can be obtained if all private insurance companies are ready to pool their information on prescriptions that have been dispensed in retail pharmacies. Success with this procedure requires a willingness and openness of the insurance companies to provide proprietary information to third parties. Second, a comparable technical environment is required for all parties involved in order to have prescriptions coded and delivered in a similar, fast and reliable way. Third, if data regarding pharmaceutical sales for just one insurance company is missing, the validity. the data may be highly distorted. It is generally not possible to estimate the part of missing insured parties from inside the census information supplied by other insurance companies. Moreover, the costs associated with data supplier fees and high technical investment may be prohibitive. Thus, the method of census data remains disadvantageous.

A second method of estimating pharmaceutical sales to patients covered by private insurance allocated by prescriber location involves taking a sample of data from pharmacies for prescriptions that have actually been dispensed. This method requires a very large sample due to the division of the geographical region into a large number of small geographical segments and for advanced data collection techniques. To achieve a high level of statistical confidence under such circumstances, a minimum number of 5-7 pharmacies may be required for each geographical segment, which can accumulate to an overall sample of 10,000-15,000 pharmacies, if approximately 2,000 geographical bricks are desirable. For processing such a large sample of data in a reasonable time frame, it is desirable to collect information electronically from pharmacy computers. Consequently, only computerized pharmacies with “point-of-sale” (POS) systems are eligible for selection. POS systems, as are known in the art, are a class of software used by pharmacies and other merchants which captures data about stocks, purchases, and sales. In the case of pharmacies, POS systems allow sales on prescriptions to be subdivided into PKV prescriptions, GKV prescriptions, or sales without prescriptions as described above. The limited number of pharmacies using POS systems reduces the “recruitable universe,” which refers to the known pharmacies included in the study, to a level which in many geographical regions do not satisfy the required sample size, particularly when taking into account the empirical rate of 2 out of 3 pharmacies refusing to cooperate with the study by providing the requested information.

This method is already applied in the United States by IMS HEALTH under the product name Xponent®. A pharmacy sample of more than 30,000 pharmacies is maintained, delivering data on all prescriptions dispensed in the sample pharmacies. Prescriptions are re-distributed to the individual prescriber location bricks and projected by means of a patent-protected projection methodology. This process is described in commonly-owned Felthauser et al., U.S. Pat. No. 5,420,786 issued May 30, 1995 and Felthauser et al. U.S. Pat. No. 5,781,893 issued Jul. 14, 1998, both of which are incorporated by reference in their entirety herein.

The cost of maintaining such a large sample, however, is not economically feasible for prescriptions covered by private insurance only, in circumstances where these private prescriptions typically make up not more than 10% of the total prescription volume in a country or region. Any study on prescriptions would only be complete by including the remaining 90% of prescription volume that is reimbursable by public health insurance.

A third method of estimating pharmaceutical product sales to patients covered by private insurance allocated by prescriber location involves taking a sample of pharmaceutical products prescribed by doctors themselves. While data concerning private prescriptions could be collected from a panel of doctors—as is currently done in many countries—this procedure has the potential disadvantage that not all prescriptions by doctors are turned into sales in pharmacies. For example, a patient may choose not to fill a particular prescription; alternatively, the product prescribed may be substituted with a similar one, e.g., a generic or an equivalent product, imported in parallel with the prescribed product. Such activity introduces inaccuracies into the estimation process.

Compared with the second method which includes a sample of pharmacies, as described above, a sample of doctor's prescriptions has to be significantly larger in size to provide statistically significant data. For example, a particular medical doctor may have a limited portfolio of products that she usually prescribes. Therefore, the coverage by one individual sampling element is much smaller than for a pharmacy panel, where a larger number of different doctors prescriptions can be collected from the same pharmacy. In order to make such a doctor-based method economically feasible, data collection is typically processed through computer terminals at the doctor's offices. The disadvantages described above for a limited ‘selection universe’ and refusal rates for pharmacies is equally valid for samples involving doctors' prescription practices.

Of the above methods of estimating pharmaceutical sales to patients, the first method, which is a census of pharmaceutical sales involving pooled private insurance information, is not currently a feasible solution for collecting product sales on private prescriptions. Similarly, the third method, which is the sample of physicians prescribing practices, is not economically feasible and is not most suitable to estimating sales since by prescriber location prescriptions do not necessarily correlate with sales. The second method, which refers to estimating methods involving large-scale pharmacy samples that are representative of geographical segments cannot be generated effectively at present due to the limited technical environment, the high costs of data collection, and the insufficient speed of data delivery.

Accordingly, there exists a need for a statistical methodology that keeps the sample of pharmaceutical sales data at a reasonable size, while still providing an acceptable level of accuracy.

### SUMMARY OF THE INVENTION

An object of the present invention is to provide a technique of combining census data on related, but not identical, variables in order to enhance the value of sampled data.

Another object of the present invention is to provide reliable estimates of selected fields of data relating to very small sampling segments even without having sample data generators (such as pharmacies) in every sampling segment.

A further object of the present invention is to produce detailed reports on selected fields of data in regions where those fields of data are usually not captured via computer, where computer systems are not yet widespread in data generating environments (such as pharmacies) thus resulting in a limited sample size, and to keep data collection and production at reasonable costs at the same time

These and other objects of the invention, which will become apparent with reference to the disclosure herein, are accomplished by a system and method for estimating product sales to one class of purchasers (e.g., patients covered by a first insurance program) allocated into a plurality of geographical segments based on a server provider location, wherein a plurality of said geographical segments constitute a geographical region. A mass storage device is provided which stores census data, near-census data, and sampled data. Census data of product sales to data generating sales outlets includes a plurality of data records, wherein each census data record includes product type information and the geographical segment corresponding to the data generator location, such as pharmacy bricks.

Near-census data of pharmaceutical product sales to patients covered by a second insurance program includes a plurality of data records, wherein each near-census data record includes product type information, the geographical segment corresponding to the pharmacy location, and the geographical segment corresponding to the prescriber location. Pharmaceutical product sales to pharmacies and to patients are included in the sampled data, where each sample data record includes product type information and the pharmacy location. All sample data record may be allocated to the respective geographical region corresponding to the pharmacy location. An input device receives the census data, the near-census data, and the sampled data into the system.

A computer processor is programmed to perform a series of processing steps. For each geographical region, the projected pharmaceutical product sales to patients is preferably determined by applying a first proportional factor to the sampled pharmaceutical product sales to patients. The first proportional factor preferably includes, for the geographical region, a ratio of the census pharmaceutical product sales collected to the sampled pharmaceutical product sales sampled.

For each geographical region, the projected near-census data for pharmaceutical product sales to patients covered by the second insurance program preferably is determined by applying, for each geographical segment, a second proportional factor to the near-census data of pharmaceutical product sales to patients covered by the second insurance program. The second proportional factor preferably includes, for each geographical segment, a ratio of a total number of dispensing pharmacies from the census data to a total number of dispensing pharmacies collected in the near-census data. The projected near-census data for each geographical segment is preferably aggregated to the respective geographical region.

For each geographical region, the adjusted pharmaceutical product sales to patients covered by the first insurance program may be determined by applying an adjustment factor to the projected pharmaceutical product sales to patients covered by the first insurance program. The adjustment factor is preferably a ratio of the projected pharmaceutical product sales to patients covered by the second insurance program and the projected near-census data for pharmaceutical product sales to patients covered by the second insurance program.

Pharmaceutical product sales to patients covered by the first insurance program allocated by geographical segment of the pharmacy location are estimated by applying first split-factors to the adjusted pharmaceutical product sales to patients covered by the first insurance program. The first split-factors is, for each product type and for each geographical segment, a proportion of pharmaceutical product sales to pharmacies in the geographical segment with the total pharmaceutical product sales in the respective geographical region based on the census data of pharmaceutical sales.

Pharmaceutical product sales to patients covered by the first insurance program allocated by the geographical segment of prescriber location, are estimated by applying second split-factors to the estimated pharmaceutical product sales to patients covered by the first insurance program allocated by geographical segment of pharmacy location. The second split-factors is, for each geographical segment of pharmacy location, a proportion of a total number prescriptions in each geographical segment of prescriber location with a total number of prescriptions in the respective geographical segment based on the projected near-census data of pharmaceutical product sales to patients covered by the second insurance program.

In accordance with the invention, the objects as described above have been met, and the need in the art for a statistical methodology that keeps the sample of pharmaceutical sales data at a reasonable size, while still providing an acceptable level of accuracy, has been satisfied. With this invention, it is possible to keep the size of a pharmacy sample relatively small and economically feasible, while accessing census or quasi-census sources of wholesaler sales into geographical segments and prescriptions covered by a second insurance program originating from the same geographical segments. Further features of the invention, its nature and various advantages will be more apparent from the accompanying drawings and the following detailed description of illustrative embodiments.

### BRIEF DESCRIPTION OF THE DRAWINGS

FIG. 1 is a flow diagram of a first portion of an exemplary method in accordance with the invention.

FIG. 2 is a flow diagram of second portion of the exemplary method in accordance with the invention.

FIG. 3 is a flow diagram of a third portion of the exemplary method in accordance with the invention.

FIG. 4 is a flow diagram of a fourth portion of an exemplary method in accordance with the invention.

FIG. 5 is a simplified block diagram of an exemplary system in accordance with the invention.

### DETAILED DESCRIPTION OF THE INVENTION

The present invention provides techniques for estimating sales of product sales to one class of purchasers and to allocate these product sales into the geographical segments corresponding to the location of the service provider. The invention is fully applicable to regions divided into geographical segments and having access to sales data from a variety of sources, such as census data, near-census data, and sampled data. The data for each sale or transaction may contain information on (a) the type of product; (b) the location of the service provider, (c) the location of the data generator, and (d) the category of the sale or transaction.

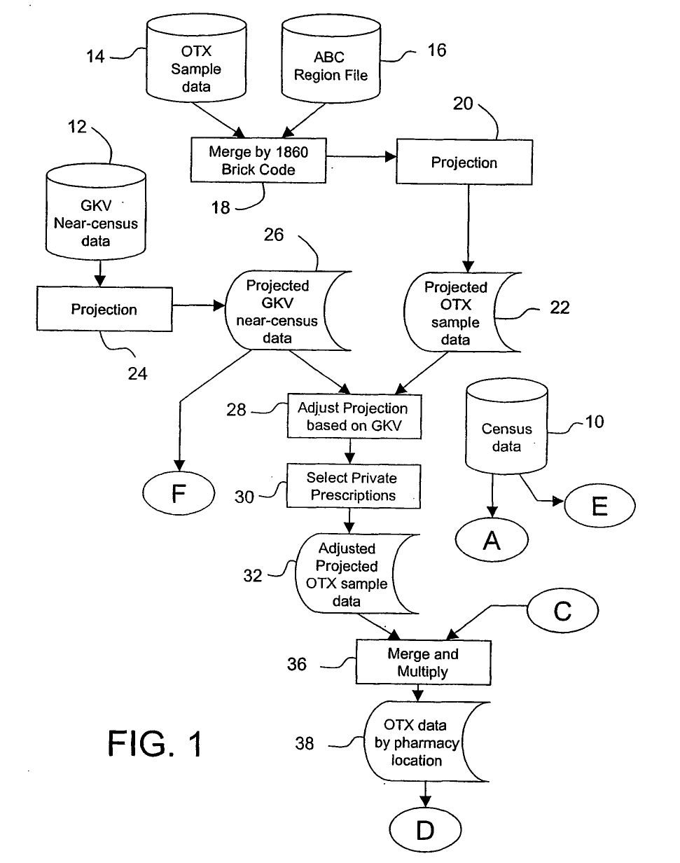

In the description which follows, an exemplary embodiment of the invention was a procedure to estimate pharmaceutical sales to patients covered by private insurance in Germany. The techniques described herein are not specific to Germany, and may be used in other regions. Examples of the technique in Switzerland and Korea will be described in greater detail below. A flow chart of the process of the invention is illustrated in FIG. 1. According to the exemplary German model, there are at least three categories of retail sales to patients: (1) prescriptions are covered by private insurance (hereinafter referred to as “PKV prescriptions”, or covered by a “first insurance program.”); (2) prescriptions reimbursed by social health insurance (hereinafter referred to as “GKV prescriptions” or covered by the “second insurance program.”); and (3) prescriptions that are sold by pharmacies and are not covered by any insurance program. Additional exemplary categories of transactions, as described below, are purchases from wholesalers, also referred to as “indirect purchases” and purchases from manufacturers. Additional categories may be used to characterize the type of transaction.

In the exemplary embodiment, the country is divided into 1,860 “bricks,” also referred to as “geographical segments.” For purposes of this application, the terms “bricks” and “geographical segments” are interchangeable to denote the smaller geographical division of the country or region being studied. The data concerning pharmaceutical product sales may be broken down into the 1,860 bricks, both by location of the service provider, i.e., the prescribing physician, and by location of the data generator, i.e., the dispensing pharmacy. The 1,860 bricks are amalgamated into 66 geographical regions, also referred to as “ABC-regions.” For purposes of this application, the terms “ABC-regions” and “geographical regions” are interchangeable to denote the larger geographical division in the country or region being studied.

These ABC-regions are a hierarchical amalgamation of the 1,860 bricks. According to this system, neighbored bricks with a similar purchase power are combined to one ABC-region. Data regarding the 66 ABC-regions are stored in the ABC-region file 16. It is understood that the selection of 1,860 bricks and 66 ABC-regions was selected in view of the population distribution in Germany and to provide satisfactory statistical results, and that other breakdowns are possible for other countries or locations are within the scope of the invention. For example, in the United States, the geographical region and geographical segment relationships could be established by using existing ZIP code, county, and state boundaries. The results can be further broken down to ZIP+4 code region within a single “brick.” A different method of breakdown of data would be used in Hungary. In Hungary, the available wholesaler census data are stored on ZIP-code level. There are approx. 1,300 ZIP-codes being studied. These ZIP-codes may-be considered the equivalent of the 1,860 bricks in Germany. These ZIP-codes can be hierarchically amalgamated to so-called “Kistersegs,” which are official administrative regions. Hungary has 172 Kistersegs. These Kistersegs may be considered the equivalent to the 66 ABC-regions in Germany. A further aggregation is possible to the 20 official Hungarian counties.

As another example, the techniques may be used to estimate sales data in Switzerland. As with Germany, census data of wholesalers is available in Switzerland. Switzerland is divided into 146 bricks, compared with 1,860 bricks for the German model. Near-census GKV data (as defined above) could be collected from a “pharmacy coding centre,” referred to as OFAC, which covers 70% of reimbursable prescriptions. Furthermore, IMS Health maintains a pharmacy panel of 200 sample pharmacies. These sample pharmacies, depending on the software system they use, could provide the type of sample data as identified in Table 3, below. Approximately 20% of all prescriptions in Switzerland are PKV-prescriptions (defined above), as reported by the local IMS Health office. Some of the sample pharmacies provide sales broken down into the sales categories 1-3, as defined below. (Categorizing sales by type would require that sample pharmacies be equipped with the appropriate POS system.) With collaboration of OFAC to obtain near-census GKV data, and availability of sample data broken down into sales categories 1-3, the German model using the computational techniques of this invention is also useful in Switzerland.

The techniques described herein could also be used to estimate sales data in Korea. Census data of wholesalers may be obtained from available information. Currently, information for a sample of wholesalers covers approximately 35% of the pharmaceutical retail market. To achieve census level, the data would have to be projected to the universe by known methods. Furthermore, GKV-type of data (defined above) may be obtained from companies or institutions which use pharmacy software that prepares the so-called “NHI claim files.” (NHI prescriptions are the equivalent to the GKV data.) Software systems of this type are provided, e.g., by Medidas Co., Ltd., of Seoul, Korea, and by the Pharmacy Association of Korea. Systems provided by Medidas and/or the Pharmacy Association of Korea have equipped approximately 75%-80% of all Korean pharmacies. Consequently, a source of near-census data would available for use in the estimating process. Sample data could be collected from a pharmacy panel which is maintained by IMS Health. Currently, 398 pharmacies are included in this pharmacy panel. For the sample data, however, a POS system or similar, would be implemented in order to collect product sales data by sales category 1-3.

As described below, the present invention provides a process to integrate a plurality of different data sources in order to execute the full statistical process of combination and estimation. The data sources may be divided into at least three groupings: census data 10, “near-census” data 12, and sample data 14. The census data 10 is substantially complete and does not require projection to compensate for missing data. The near-census data 12 is nearly complete, therefore some projection is required, as is described in greater detail herein. The sample data 14 is an approximately 10% sample of known pharmacies and is subsequently projected to 100%. The census data 10, near-census data 12, and sample data 14 are described in greater detail below.

The census data 10 is collected from a number of wholesaler depots, e.g., approximately 102 wholesaler depots in the exemplary embodiment, and parallel importing companies, e.g., approximately eleven importing companies in the exemplary embodiment. The census data 10 provides complete information on sales of pharmaceutical products by wholesalers to retail pharmacies. In the exemplary embodiment, no projection is required as this is full census information, and no other suppliers are considered active in the market. For each pharmaceutical product denoted by a proprietary product form code FCC, unit sales from wholesalers to retail pharmacies are collected and provided on the level of 1,860 bricks. This information covers approximately 85% of the total retail pharmacy market. Since this process is primarily concerned with pharmaceutical product sales that are conducted from the manufacturer to the wholesaler, from the wholesaler to the retail pharmacy, and from the retail pharmacy to the patient, direct sales from the manufacturer to the retail pharmacy are excluded. The remaining 15% of the total retail pharmacy market comprises such excluded direct sales data.

In the exemplary embodiment, data is collected and processed monthly. The data structure used for the invention is represented in Table 1. The data structure includes information about the product type, i.e., product form code FCC, and the 1,860-brick corresponding to the location of the dispensing pharmacy, i.e., pharmacy brick.

TABLE 1

| VARIABLE | START COLUMN | LENGTH | FORMAT |
|---|---|---|---|
| Product Code | 2 | 4 | Packed Decimal |
| Pharmacy Brick | 6 | 4 | Packed Decimal |
| (1,860-Brick) | | | |
| Units (Pack sales to | 15 | 4 | Packed Decimal |
| retail pharmacies) | | | |

The near-census data 12 is collected from pharmacy coding centers which maintain records of pharmaceutical sales, e.g., there are 14 pharmacy coding centers in the exemplary embodiment. The near-census data 12 includes the sales of pharmaceutical products induced by prescriptions covered by a second insurance program, i.e., the social health insurance program in the exemplary embodiment. The data is summarized to 1,860-brick level, and includes information about the product, i.e., product form code FCC, the 1,860 brick corresponding to the location of the dispensing pharmacy, i.e., pharmacy brick, and the 1,860 brick corresponding to the location of the prescribing physician, i.e., prescriber brick. The pharmacy coding centers cover approximately 95-98% of the total pharmacies. A small segment of the data, typically less than 5%, cannot be allocated to the prescriber brick; thus the data is considered “near-census” or “quasi-census” rather than census. The coverage percentages may be different in each 1,860-brick, depending on the business relationship of pharmacies with cooperating coding centers. Any missing data is compensated for by projection, as is described in greater detail below.

In the exemplary embodiment, data collection is at least as frequently as monthly and for the invention, the data structure that is used is represented in Table 2.

TABLE 2

| VARIABLE | START COLUMN | LENGTH | FORMAT |
|---|---|---|---|
| Product Code | 2 | 7 | Numeric |
| Pharmacy Brick | 9 | 7 | Numeric |
| (1,860-Brick) | | | |
| Prescriber Brick | 16 | 7 | Numeric |
| (1,860-Brick) | | | |
| Period | 25 | 6 | Numeric |
| Units (Pack sales to | 31 | 4 | Packed Decimal |
| public patient) | | | |

The sample data 14 is obtained from a sample of pharmacies, e.g., 2,200 pharmacies are sampled in the exemplary embodiment. The following data on product form level is collected and represented in Table 3: information on product type, i.e., product form code FCC, pharmacy location, number of units, and the category of transaction: (a) Purchases from Wholesalers (“indirect purchases”); (b) Purchases from manufacturers; (c) Sales to patients, i.e., the public, covered under a first insurance program, e.g., PKV prescriptions (sales type 1); (d) Sales to patients, i.e., the public, covered under a second insurance program, e.g., GKV prescriptions (sales type 2); and (e) Sales to the public without prescriptions (sales type 3).

TABLE 3

| VARIABLE | START COLUMN | LENGTH | FORMAT |
|---|---|---|---|
| Product Code | 1 | 7 | N |
| Sample Shop Code | 8 | 7 | N |
| Sales Type | 15 | 1 | N |
| Units (Pack units | 17 | 5 | PD |
| dispensed) | | | |

In the exemplary embodiment, sample data 14 is collected in electronic form on a weekly basis and projected to the entire universe of pharmacies. Additionally, on a monthly basis, the sample pharmacies report on their stock level. The data are stored on electronic media and mailed or sent via Internet for data processing. The sampling and projection methods are explained in detail below.

As will be described in greater detail below, the sample data 14, which represents a portion of all pharmaceutical sales, is projected, such as multiplied by a proportional factor, to represent total pharmaceutical sales. Accordingly, sample data 14 on indirect purchases should be identical to the census data 10 of wholesaler sales to retail pharmacies, above. Similarly, sample data 14 for GKV prescriptions which has been projected would be identical to the near-census data 12 for such GKV prescriptions. The relationships between the three datasets are used to correct sample-based projections on pharmaceutical sales to patients covered by private insurance. The census data 10, the near-census data 12, and the sample data 14 are integrated and combined in accordance with the invention by using a set of tools and processes which is described herein with reference to FIGS. 1-3.

The sample data 14 related to pharmaceutical product sales induced by prescriptions are collected from a well-defined sample of retail pharmacies and projected by turnover ratios to the “universe,” which refers all known pharmacies. The data sampling process involves obtaining data on the pharmacies and the total sales in each pharmacy, i.e., ‘turnover.’ The regional breakdown comprises a number of macro regions and micro regions, e.g., there are 17 macro regions and 490 micro regions in the exemplary embodiment. The shop counts for the 490 micro regions may be obtained from a number of sources. The breakdown into classes based on turnover is derived from information collected from the statistical offices of the states and, in addition, from statistical offices of selected large cities. Wherever this collected universe information is an aggregate of several micro regions, wholesaler census data are used to estimate the turnover per pharmacy size class in the individual micro regions. By this combination of wholesaler census data and external official information, a precise compilation of the universe data is obtained. In the exemplary embodiment, the universe data are collected on an annual basis. The time lag of the official statistics is two years. By means of trend extrapolation the current status is being reflected.

In the exemplary embodiment, the design for the sample data 14, i.e., the ‘OTX sample,’ is stratified into 16 states, in which Berlin is further subdivided into West and East, resulting in 17 macro regions. Within each macro region, the design is stratified into so-called micro regions, resulting in a total of 490 micro regions. It is noted that the micro regions and micro regions described herein are used for obtaining a statistical sample of pharmaceutical data and is distinguished from the geographical segments (bricks) and regions used to estimate total sales data. Each micro region is stratified into 3 turnover-size classes. Hence, the total number of design cells is 1470. The 490 micro segments can be completely generated out of the 1,860 bricks.

The pre-defined total sample size of 2,200 pharmacies is distributed disproportionately over the 490 micro regions. Within each micro region, a ‘proportional-by-size’distribution model is used to allocate the sample elements to the turnover-size classes. The ‘proportional-by-size’ allocation of the sample allows deliberate over-sampling of pharmacies having larger turnover, thus optimizing the information content for a given sample size. It is noted that other well-known methods may be employed to sample pharmaceutical sales data.

An alternative, well-known sampling approach would be a pure probability sampling. This requires that the actual selection of pharmacies into the sample is steered, e.g., by the following process: serial numbers are assigned to each pharmacy in the universe and a sample is selected by randomly selecting serial numbers. According to this process, a step (S) is defined as follows:

$$S = \frac{\text{Universe}}{\text{Sample}} , \text{rounded to the next integer}$$

Assume the number of Universe elements (doctors, pharmacies etc.) in a stratum (region, speciality etc.) amounts to 49 and the sample design requires the recruitment of 10 Sample elements. Hence, S is calculated as

$$S = \frac{49}{10} = 4.9 \approx 5$$

Select randomly a number R between 1 and S. This is the starting point of the random selection. Continuing with the example, assume R=3. Hence, the first element of the sample selection is the 3^{rd} universe element listed in the universe list. To select the next sample element, S has to be added to the index number of the previous one. The general index formula is:

Eᵢ=Eᵢ₋₁+S

E₁=R

where Eᵢ is the i^{th} sample element to be selected. Using the above example, the following sample elements have to be selected:

Eᵢ=3

E₂=3+5=8

E₃=8+5=13

Hence, the 3^{rd}, 8^{th}, 13^{th}, etc. element in the universe list has to be selected for the sample. If a sample element does not respond, you choose the preceeding or following one from the list.

The estimation of the total market data is achieved through a projection of the OTX sample data 14 (step 20 in FIG. 1). The projection factors per design cell, e.g., PFS, are calculated as the ratio of the annual universe turnover versus the annual sample turnover in the given week. Monthly OTX data are obtained through an addition of the weekly data. In cases where a week crosses the calendar month, the projected data of the week are apportioned proportionally by the number of weekdays to the subsequent calendar month.

This projection method is known as ‘turnover-based and stratified projection’. This projection method reduces the statistical error margin of the final estimates significantly when compared to a straight-forward projection based on store-count relations.

Since the sample size is typically too small to obtain projected data on the level of the 1,860 bricks, the OTX sample data 14 in step 18 are aggregated on the ABC-regional level, respecting sufficient sample numbers per projection cell. This regional breakdown consists of 66 different ABC-regions in Germany, but may there may be a different number of regions in other countries. The aggregation of bricks or geographical segments to ABC-regions follows the principles of homogeneity with regard to socio-economic parameters such as purchasing power, population density, and degree of urbanization. The projection factors are calculated and applied on the level of these ABC-regions, thereby producing the projected OTX sample data 22 (see FIG. 1). An example of calculating the projection factor PFS, is provided below with equation [13.

As it cannot be assured that the projected OTX sample data 22 are unbiased, a specific bias measurement and adjustment procedure has been developed. This method combines the near-census GKV prescription data 12, i.e., the pharmaceutical sales to patients covered by the second insurance program, with the projected OTX sample data 22 on the level of the ABC-region so as to identify eventual biases and to apply correction factors. As described above, the projected OTX sample data 22 contains information about pharmaceutical sales covered by private insurance, public ‘sick-fund’ insurance, etc. In the exemplary embodiment, the projected OTX sample data 22 is corrected by comparing the sample data for GKV prescription prescriptions with near-census data for GKV prescriptions. The resulting adjustment factor is applied to all the projected OTX sample data 22, including sales data for GKV prescriptions and PKV prescriptions.

More specifically, the near-census GKV prescription data 12 requires some projection. At step 24, the near-census GKV prescription data 12 is projected by applying a proportional factor PFG. As will be described in the example below, the proportional factor PFG for each 1,860-brick represents the ratio of known, i.e., universe, pharmacies, to the number of pharmacies included in the records of the pharmacy coding centers, and thus reflected in the near-census GKV prescription data 12 (see equation [2]).

The 1,860-bricks are building-blocks for the 490 micro regions of the data sample, hence also for the 66 ABC-regions. The GKV prescription data for the 1,860 bricks is aggregated to the 66 ABC-regions, to obtain the projected GKV prescription data 26, which is written to a file. The projected near-census GKV prescription data 26 is on the same regional level as the projected OTX sample data 22 for GKV prescription prescriptions. Thus, a comparison between both sources of data is made to occur. The combination of these two data sets allows a correction of a possible bias of the projected sample data, since these data sets are on a compatible data level, both region-wise and type-wise.

The projected OTX sample data 22 is adjusted in each of the 66 ABC-regions at step 28 by applying an adjustment factor ƒₖ to the projected OTX sample data 22. As will be described in greater detail below, the adjustment factor ƒₖ is a ratio of the projected OTX sample data 22 for each ABC-region and the projected near-census GKV prescription data 26 for each ABC-region (see equation [3]).

The procedure of the invention is directed to pharmaceutical sales that are covered by private insurance, e.g., the first insurance program, or PKV prescriptions. Thus the projected OTX sample data 22, after being adjusted at step 28, is filtered at step 30 to include only data for private prescriptions to create the projected OTX/PKV sample data file 32. It is understood that the projected sample data could be filter to include a different insurance program.

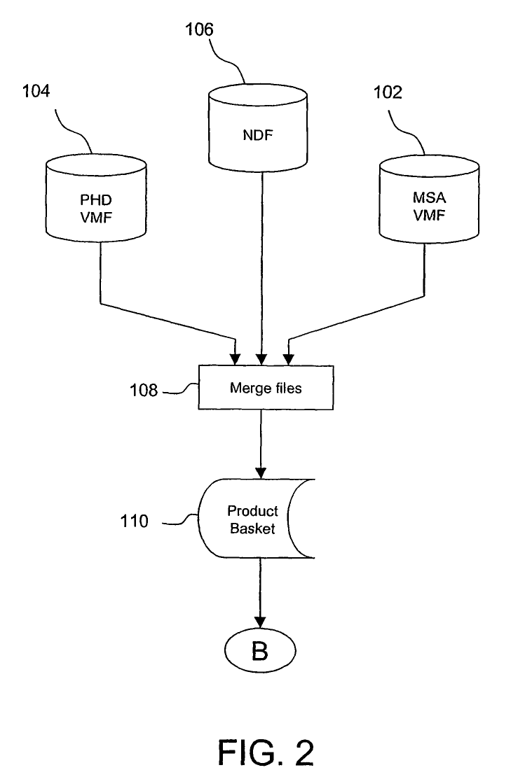

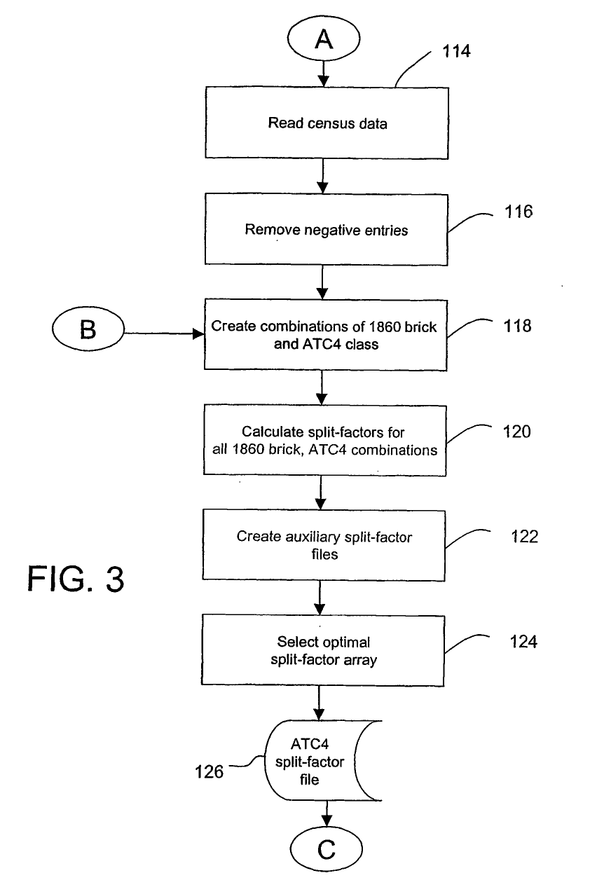

With reference to FIGS. 2-3, further steps in the process, which may be performed concurrently with the steps described above, includes the product basket generation and calculation of split factors. The projected OTX/PKV sample data 32, for which estimates are obtained on the 66 ABC-regional level as described above, are subsequently re-distributed across the 1,860 bricks corresponding to the location of the dispensing pharmacy, or by “pharmacy brick.” The distribution data are derived from the wholesaler census data 10, above. However, since this data source only reports on deliveries from pharmaceutical wholesalers to retail pharmacies, but not on direct sales from pharmaceutical manufacturers to retail pharmacies, only a portion of the wholesaler data is taken into consideration to obtain the relevant distribution data. More specifically, only those products are taken into account for this purpose that are predominantly sold through wholesalers. Products with a large portion of direct sales would distort the distribution process as such products are not precisely reflected in the census data.

The definition of such products which meet the above criteria is based on the combination of projected OTX/PKV sample data 32 and the wholesaler census data 10. The resulting product selection, hereinafter referred to as the “product basket,” is used to calculate the distribution data.

The distribution is calculated by product classification, rather than by a particular product. In the exemplary embodiment, the distribution is calculated on the ATC level (i.e., the “Anatomical Classification of Pharmaceutical Products” developed and maintained by the European Pharmaceutical Marketing Research Association (EphMRA), which is incorporated by reference in its entirety herein) since the occurrence of pharmaceutical dispensations has been found to be dependent on the morbidity structure of the patient population, rather than on an individual product. This is indirectly reflected by the ATC classification of products. The distribution figures are calculated on the lowest level, which is the ATC4 level (fourth level of Anatomical Classification) in the exemplary embodiment.

Product basket generation/Split factor correction 34 is illustrated in greater detail in FIGS. 2-3. A first step in the product basket generation is to merge several input datasets, as illustrated in FIG. 2. In the exemplary embodiment, the data is read from data files referred to as the MSA-VMF 102 (i.e., medical supplies study of Germany) and the PHD-VMF 104 (i.e., retail pharmacy study of Germany). The VMF data files 102/104 carry the product form code FCC, and other information such as the pack units and prices for a period of time (e.g., 24 months). The direct sales are also included as a special record type, and are thus identifiable. (The MSA-VMF 102 also includes medical supplies products, such as bandages, plasters, etc., which are not featured in the retail pharmacy study in Germany.) Since the VMF data files 102/104 contain sales data, the contents of these data files changes from month to month.

Next, the German NDF 106 (i.e., national description file) is read. The NDF 106 carries relevant information for each product form code FCC. For example, the NDF 106 includes complete product descriptions including product name, manufacturer, price, etc. More importantly, the NDF 106 includes the ATC4 classification associated with each product form code FCC. In contrast with the VMF files 102/104, the contents of the NDF 106 are typically unchanged from month to month.

Subsequently, each VMF file 102/104 is merged with the NDF 106 at step 108. These intermediate files for description purposes may be referred to as PHD_NDF (resulting from the merging of the PHD-VMF and the NDF) and MSA_NDF (resulting from the merging of the MSA-VMF and the NDF). Merging denotes a well-known program technique to join two or more data files that have at least one variable in common. The purpose of merging is to create a new data file that holds information from the data files that were submitted into the merging process. In the basket generation, the common variable is the product form code FCC. The data file resulting from the merge of the VMF data files and the NDF carries the product form code FCC, the summarized units data of the current month and the 2 months prior the current month, and the ATC4.

Thereafter, these two files (PHD_NDF and MSA_NDF) are merged together and filtered, in which the product form code FCC is the common variable. For matching records (i.e., a product form code FCC is featured in both in PHD_NDF and MSA_NDF), the PHD_NDF data is kept in the resulting data file. If a product form code FCC is only featured in the PHD_NDF, the data is kept in the resulting data file. If a product form code FCC is only featured in the MSA_NDF, the data is kept in the resulting data file. The resulting data file is the product basket which is written at step 110. The product basket file format is indicated in Table 4.

TABLE 4

| | START | | |
|---|---|---|---|
| VARIABLE | COLUMN | LENGTH | FORMAT |
| Product Code | 1 | 7 | Numeric |
| Pack units Direct | 8 | 12 | Numeric |
| Sales (Direct | | | |
| sales of 3 months, | | | |
| including the current | | | |
| month) | | | |
| Pack Units Total | 20 | 12 | Numeric |
| Sales (Total sales | | | |
| of 3 months, including | | | |
| the current month) | | | |
| ATC4 | 40 | 5 | Alpha-numeric |
| Control Flag | 46 | 1 | Alpha-numeric |

The product basket carries all products forms on which the subsequent calculation of split factors is based.

With reference to FIG. 3, the census data 10 is read at step 114. Subsequently, negative data entries are removed at step 116. The census data 10 shows net sales, which includes the number of units sold less the number of units returned. If the sales are lower than the returns, the net sales would be negative. When such negative entries occur, they are removed, i.e., deleted, from the census data 10.

The product basket is read, and all possible combinations of 1,860 brick i and ATC4 classification are created in step 118. Subsequently, at step 120, a split-factor Sᵢ(ATC4) is calculated for each combination of 1,860 brick i and ATC4 classifications created at step 118. As will be described in greater detail in the example below, the split factor represents, for each ATC4 classification, the proportion of wholesale product sales in a 1,860-brick with the total wholesale product sales in the respective ABC-region based on the census data 10 (see equation [4]).

Due the large number of split-factors that are generated at steps 118-120, several optimizations may be performed. For example, at step 122, auxiliary split factors files may be created on higher ATC-levels. Since the ATC provides a hierarchical classification, there would be fewer combinations of 1,860-bricks and ATC classifications at the next higher level. (For example, the product Nasivin™ belongs to the ATC4 R01A7 (i.e., Nasal decongestants). The next higher ATC level is R01A (i.e., topical nasal preparations). The next higher level from R01A is R01 (i.e., nasal preparations). The next higher level from R01 is R (i.e., respiratory system). Thus, going from the level of R01A7 to the level of R01A involved fewer total ATC classifications.)

Another optimization is to truncate the split factors calculated at step 120, by eliminating split factors that are below a threshold amount and recalculating the split factors, as described in greater detail below in the example (See equation [5]). The optimal split factor array is selected at step 124, in which the ‘optimal’ array is defined as a split factor array having non-zero values for all bricks. The final split factor file is written at step 126.

With continued reference to FIG. 1, the split factors are applied at step 36. The split factor file and the adjusted, projected OTX/PKV sample data file 32 are read. The adjusted, projected OTX/PKV sample data 32 for each ABC-region is multiplied by each of the split-factors corresponding to bricks within the respective ABC-region. As a result, a data record for pharmacy location (dispensing brick) is generated for each of the 1,860 bricks. The sum of the generated data records equals the total pharmaceutical sales of that ABC-region. After the application of the ATC4 split-factors, the distributed, projected OTX/PKV sample data 38 is determined for dispensing pharmacy location.

In order to compensate for the varying intensities of private prescribing vs. GKV prescriptions, a correction index is used, also referred to as a “PRIMAX” correction, illustrated in FIG. 3. For the adjusted, projected OTX/PKV sample data 38, those products are selected having a significant share of private prescriptions and an insignificant share of direct sales from manufacturers to wholesalers at step 40. The data is merged at step 42 with the census wholesaler data 10 for the products selected in step 202 only. These private prescription products are identified in each 1,860-brick and their share of the total 1,860-brick volume is calculated at step 44. For each 1,860-brick a specific indicator is calculated at step 46 as the ratio of the average share of the selected private prescription products for a 1,860-brick (as calculated in step 44) over the average share of the selected private prescription products for the ABC-region in which the 1,860-brick is located. The PRIMAX correction factor is described in greater detail below in the example (See equation [6]).

This PRIMAX correction takes into account the potential of any 1,860-brick as prone to private prescriptions in relative terms. It is much more indicative as, for example, general indices for purchasing power, which regularly combine household expenditure for a large array of commodities. PRIMAX considers only private prescriptions and is, therefore, suitable for a refinement of the projected OTX sample data.

In accordance with the invention, the procedure performs a further re-distribution of the adjusted, projected OTX/PKV sample data from the pharmacy brick to the prescriber brick at step 48. The respective split-factors d_{.,j} are derived from the projected near-census GKV prescription data 26. In general terms, the split factors d_{.,j} are represented as the relative weight of each prescriber brick that contributes to the dispensations occurring in a specific pharmacy brick. More specifically, the split-factor d_{.,j} is a proportion of pharmaceutical sales in each 1,860 pharmacy brick attributable to a particular prescriber brick with the total pharmaceutical prescriptions in the respective pharmacy brick. The underlying assumption for this procedure is that the relation between pharmacy brick and the corresponding prescriber bricks is reflected by the prescribing activity of the doctor population. This activity is precisely reflected by the near-census GKV prescriptions data 12, as projected at step 24, above. An example of the calculation of the split factors is provided in the example (see equation [6]).

The PRIMAX correction factor as calculated in step 46 and the split factors d_{.,j} calculated in equation [6], below are applied to the adjusted, projected OTX/PKV sample data 38 at step 48. Optionally, the PRIMAX correction of steps 40-46 may be omitted. In such case, the split-factors d_{.,j} are applied to the adjusted, projected OTX/PKV sample data 38 only.

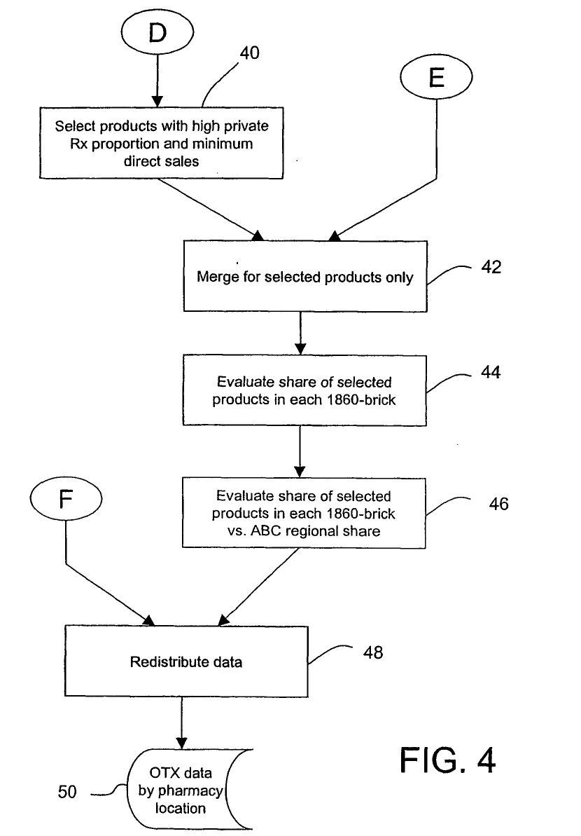

The application of the various split-factors results in many cases in fractions of pack units. As the reporting is on integer numbers only, rounding has to take place. The standard rounding procedure, however, would introduce a disproportionate error in the final estimates. Therefore, the Hare-Niemeyer rounding approach is used, as is known in the art. The rounding approach is applied to the OTX data set 50, illustrated in FIG. 4.

The estimation process, as described above, is the combination of the three data sources as described above. A more detailed description of the equations used in FIGS. 1-4 are described herein.

Table 5 defines the variables used in connection with the process of projecting the OTX sample data as described above with respect to step 20. More particularly, the sales data which has been sampled may be divided into 1-3 turnover classes, based on the amount of sales in a particular pharmacy. Equation [1] is used to calculate the projection factor PFS for each ABC-region, and for each turnover class.

TABLE 5

| Variable/Index | Explanation | Value Range |
|---|---|---|
| k | Index for ABC-regions | k = 1, ... , 66 |
| i | Index for turnover-size classes | i = 1, 2, 3 |
| TN | Universe turnover | n/a |
| Tn | Sample turnover | n/a |
| PFS | Projection factor for OTX sample data | 1 ≦ PFS ≦ TN |

$${PFS}_{k , i} = \frac{{TN}_{k , i}}{{Tn}_{k , i}} \qquad [ 1 ]$$

for Tn_{k,i}>0. Where Tn_{k,i}=0, the universe turnover TN and the sample turnover Tn is summarized over 2 or 3 turnover size classes within the ABC-region and weighted average projection factors are calculated.

These projection factors PFS are applied to all collected sales data types, i.e., private insurance PKV prescriptions, social health insurance GKV prescriptions, and uninsured prescriptions, resulting in 3 data sets of projected OTX sample data. EXAMPLE

For any ABC-region k the relevant data is represented in Table 6.

TABLE 6

| Variable | Explanation | Value |
|---|---|---|
| TN₁ | Universe turnover in turnover-size class i = 1 | 20,000 |
| TN₂ | Universe turnover in turnover-size class i = 2 | 15,000 |
| TN₃ | Universe turnover in turnover-size class i = 3 | 10,000 |
| Tn₁ | Sample turnover in turnover-size class i = 1 | 7,000 |
| Tn₂ | Sample turnover in turnover-size class i = 2 | 4,000 |
| Tn₃ | Sample turnover in turnover-size class i = 3 | 1,250 |

Then, according to equation [1] the projection factors are calculated as follows: (The notation [n] is used to denote equations, and the notation [en], is used to denote to an example in which an equation described above is used with exemplary figures to calculate a numerical result.)

$$\begin{matrix}{PFS}_{k , 1} = \frac{\text{20,000}}{\text{7,000}} = 2.86 & [ e1 ] \\ {PFS}_{k , 2} = \frac{\text{15,000}}{\text{4,000}} = 3.75 & [ e 2 ] \\ {PFS}_{k , 2} = \frac{\text{10,000}}{\text{1,250}} = 8.00 & [ e 3 ]\end{matrix}$$

As described above, GKV data is not completely captured in the near-census data 12. The effect of unequal coverage rate is compensated for by a straight-forward projection. The OTX census data 10 and the near-census GKV data 12 contains information about the number of pharmacies included in the data. Table 7 defines the variables used in calculating the projection factor PFG in step 24 (FIG. 1). This projection factor is applied in all 1,860-bricks where n<N and n>0.

TABLE 7

| Variable/Index | Explanation | Value Range |
|---|---|---|
| i | Index for 1,860-bricks | i = 1, ... , 1,860 |
| N | Number of universe pharmacies | n/a |
| n | Number of covered pharmacies | n/a |
| PFG | Projection factor for GKV data | n/a |

$${PFG}_{i} = \frac{{N}_{i}}{{n}_{i}} \qquad [ 2 ]$$

### Example For any 1,860-brick i the following data is represented in Table 8.

TABLE 8

| | | |
|---|---|---|
| N | Number of universe pharmacies in 1,860-brick i | 12 |
| n | Number of sample pharmacies in 1,860-brick i | 10 |

Then, according to equation [2], the projection factor is calculated as follows:

$${PFG}_{i} = \frac{12}{10} = 1.20 \qquad [ e4 ]$$

In order to compensate for any bias of the projected OTX sample data 22 for private prescriptions (sales type 1, as described above), specific adjustment factors on the level of the ABC-regions are calculated. These adjustment factors are derived from a comparison of the projected near-census GKV prescription data 26 with the projected OTX sample data 22 for GKV prescriptions (sales type 2). As the projected sales on GKV prescriptions constitute by far the larger amount of all projected sales on prescriptions, it can be safely assumed that these adjustment factors are also valid for the private prescriptions. The variables used in calculating the bias control factor ƒₖ in equation [3] are defined in Table 9.

TABLE 9

| Variable/Index | Explanation | Value Range |
|---|---|---|
| k | Index for ABC-regions | k = 1, ... , 66 |
| f | Bias control factor | n/a |
| OTX | Projected OTX sample units | n/a |
| GKV | Projected near-census GKV units | n/a |

$${f}_{k} = \frac{{OTX}_{k}}{{GKV}_{k}} \qquad [ 3 ]$$

Hence, for each ABC-region a specific bias control factor is calculated and thereafter applied to the projected OTX sample data 22 at step 28. By this adjustment, any overall bias of the projected OTX sample data is removed.

### Example

For any ABC-region k, the example data is represented in Table 10.

TABLE 10

| | | |
|---|---|---|
| OTX | Projected OTX sample units | 120,000 |
| GKV | Projected near-census GKV units | 118,000 |

Then, according to equation [3], the bias control factor is calculated as follows:

$${f}_{k} = \frac{\text{120,000}}{\text{118,000}} = 1.017 \qquad [ e5 ]$$

As described above, the adjusted, projected OTX data 32 may be distributed by product classification. In the exemplary embodiment, ATC4 is used for such distribution. At step 118, above, all combinations of 1,860-bricks i and ATC4 calculations are created. The ATC4 Split-Factor Calculation for each combination is indicated below in equation [4], and the variables are defined in Table 11.

TABLE 11

| Variable/Index | Explanation | Value Range |
|---|---|---|
| i | Index for 1,860-bricks | i = 1, ... , 1,860 |
| m | Number of 1,860-bricks within | 1 ≦ m ≦ 1,860 |
| | any ABC-region | |
| C(ATC4) | Census units of the product basket | n/a |
| | in any ATC4 | |
| S(ATC4) | Split-factor for ATC4 | 0 ≦ s(ATC4) ≦ 1 |
| | Ceiling value for array truncation | 0 << 1 |

$${S}_{i} ( ATC 4 ) = \frac{{C}_{i} ( ATC 4 )}{{\sum }_{l}^{m} {C}_{i} ( ATC 4 )} \qquad [ 4 ]$$

It is noted that for all the 1,860-bricks in any particular ABC-region, equation [4] fulfills

$${\sum }_{l}^{m} {S}_{i} ( ATC 4 ) = 1.$$

Hence, by multiplying the adjusted, projected OTX sample data 32 with the ATC4 split-factors obtained in equation [4], a data record is generated for each 1,860-brick embedded in the ABC-region, where the sum of the generated data records equals the total of the ABC-region. This step combines the census information 10 concerning the distribution of sales data with the volume information derived from the projected OTX sample data 32.

### Example

For any ABC-region and ATC4-level, the data used in equation [4] is represented in Table 12.

TABLE 12

| Variable | Explanation | Value Range |
|---|---|---|
| C₁ | Census units of the product basket | 16,000 |
| | in any ATC4 in 1,860-brick 1 | |
| C₂ | Census units of the product basket | 11,000 |
| | in any ATC4 in 1,860-brick 2 | |
| C₃ | Census units of the product basket | 3,000 |
| | in any ATC4 in 1,860-brick 3 | |
| C₄ | Census units of the product basket | 18,000 |
| | in any ATC4 in 1,860-brick 4 | |
| C₅ | Census units of the product basket | 22,000 |
| | in any ATC4 in 1,860-brick 5 | |

Then, according to equation [4], the split-factors are calculated as follows:

$$\begin{matrix}{s}_{1} = \frac{16 , 000}{70 , 000} = 0.23 & [ e6 ] \\ {s}_{2} = \frac{11 , 000}{70 , 000} = 0.16 & [ e7 ] \\ {s}_{3} = \frac{3 , 000}{70 , 000} = 0.04 & [ e8 ] \\ {s}_{4} = \frac{18 , 000}{70 , 000} = 0.26 & [ e9 ] \\ {s}_{5} = \frac{22 , 000}{70 , 000} = 0.31 & [ e10 ]\end{matrix}$$

To avoid unreasonably large arrays of ATC4 split-factors with negligible values as calculated in equation [4] , the split-factor array may be truncated as follows: The Sᵢ(ATC4) numbers are sorted in descending order. A cutoff is applied when

$$\begin{matrix}{\sum }_{1}^{v} {S}_{i} ( ATC4 ) \leq λ , where v \leq m , and \\ {\sum }_{1}^{v + 1} {S}_{i} ( ATC4 ) > λ\end{matrix} \qquad [ 4 a ]$$

Following this step, the original Sᵢ(ATC4) are re-based according to

$${S}_{i} ( ATC4 ) = \frac{{S}_{i} ( ATC4 )}{{\sum }_{1}^{v} {S}_{i} ( ATC4 )} \qquad [ 5 ]$$

Equation [5] fulfills the requirement that

$${\sum }_{1}^{v} {S}_{i} ( ATC4 ) = 1.$$

Based on multiplication of the ATC4 split-factor with the adjusted, projected OTX sample data 32 of step 36, described above, the projected OTX sample data is broken down from the 66 ABC-regions to 1,860-bricks (OTX/PKV data by pharmacy location 38).

The PRIMAX correction factor applied at step 46 (see FIG. 4) and is described below.

TABLE 13

| Variable/Index | Explanation | Value Range |
|---|---|---|
| i | Index for 1,860-pharmacy bricks | i = 1, ... , 1860 |
| j | Index for 66 ABC regions | j = 1, ... , 66 |
| VP | Number of units of products | n/a |
| | having a significant share of | |
| | PKV-prescriptions and in- | |
| | significant direct sales | |
| VT | Total number of units of products | n/a |
| R | Ratio of number of unit having | n/a |
| | a significant share of | |
| | PKV-prescriptions to the total | |
| | number of units | |
| P | PRIMAX correction factor | n/a |

The term VPᵢⱼ is the total sum of units related to products with a significant share of PKV-prescriptions and an insignificant share of direct sales in pharmacy brick i (and ABC region j). The term VTᵢⱼ is the total number of units in pharmacy brick i (and ABC region j). The term VP_{.,j} is the total sum of units related to products with a significant share of PKV-prescriptions and an insignificant share of direct sales in ABC region j, and VT_{.,j} is the total number of units in ABC region j.

The PRIMAX correction factor is calculated according to the following steps:

$$\begin{matrix}{R}_{. , j} = \frac{{VP}_{. , j}}{{VT}_{. , j}} , j = 1 , … , 66 ABC regions & [ 6 a ] \\ {R}_{i , j} = \frac{{VP}_{i , j}}{{VT}_{i , j}} , i = 1 , … , 1860 bricks , j = 1 , … , 66 ABC regions & [ 6 b ]\end{matrix}$$

The PRIMAX correction factor, hence, is calculated as

$${P}_{i , j} = \frac{{R}_{i , j}}{{R}_{. , j}} \qquad [ 6 ]$$

### Example

For any ABC-region j the relevant data is presented in Table 14.

TABLE 14

| ABC | | | | |
|---|---|---|---|---|
| Region j | Brick I | VP | VT | R_{i,j} |
| 1 | 1 | 10,000 | 15,000 | 0.667 |
| 1 | 2 | 12,000 | 17,000 | 0.706 |
| 1 | 3 | 15,000 | 18,000 | 0.833 |
| 1 | 4 | 19,000 | 21,000 | 0.905 |
| 1 | 5 | 20,000 | 30,000 | 0.667 |

Then, according to [6b] the ratio of units having significant share of PKV-prescriptions and an insignificant share of direct sales to the total units in ABC-region 1 is calculated as follows:

$${R}_{. , 1} = \frac{10 , 000 + 12 , 000 + 15 , 000 + 19 , 000 + 20 , 000}{15 , 000 + 17 , 000 + 18 , 000 + 21 , 000 + 30 , 000} = 0.752 \qquad [ e11 ]$$

The PRIMAX correction factors for each brick i is as follows:

$$\begin{matrix}{P}_{1 , 1} = \frac{0.667}{0.752} = 0.887 & [ e12 ] \\ {P}_{1 , 2} = \frac{0.706}{0.752} = 0.938 & [ e13 ] \\ {P}_{1 , 3} = \frac{0.833}{0.752} = 1.108 & [ e13 ] \\ {P}_{1 , 4} = \frac{0.905}{0.752} = 1.203 & [ e14 ] \\ {P}_{1 , 5} = \frac{0.667}{0.752} = 0.887 & [ e15 ]\end{matrix}$$

After applying the PRIMAX correction factor, the data may be subsequently distributed on prescriber bricks, i.e., 1,860-brick corresponding to location of prescribing physician. In accordance with the invention, an accurate source for such distribution data can be obtained from the projected near-census GKV data 26. The split factor calculation of equation [7] uses the variables defined in Table 15.

TABLE 15

| Variable/Index | Explanation | Value Range |
|---|---|---|
| i | Index for 1,860-pharmacy bricks | i = 1, ... , 1860 |
| j | Index for 1,860-prescriber bricks | i = 1, ... , 1860 |
| W | Number of prescriber bricks re- | n/a |
| | ported for any given pharmacy | |
| | brick | |
| | Ceiling value for array truncation | 0 << 1 |
| G | Projected GKV units | n/a |
| D | Split factor | n/a |

The split-factors for any pharmacy brick is given by

$$d . {,}_{j} = \frac{{G}_{. {,}_{j}}}{{\sum }_{1}^{w} {G}_{. {,}_{j}}} \qquad [ 7 ]$$

in which equation [6] fulfills

$${\sum }_{1}^{w} {d}_{. ,} i = 1.$$

### Example

For any 1,860 pharmacy brick, the exemplary data is represented in Table 16.

TABLE 16

| Variable | Explanation | Value |
|---|---|---|
| G.,₁ | Projected GKV units | 14,000 |
| | in 1,860-prescriber brick 1 | |
| G.,₂ | Projected GKV units | 3,000 |
| | in 1,860-prescriber brick 2 | |
| G.,₃ | Projected GKV units | 800 |
| | in 1,860-prescriber brick 3 | |
| G.,₄ | Projected GKV units | 300 |
| | in 1,860-prescriber brick 4 | |
| G.,₅ | Projected GKV units | 50 |
| | in 1,860-prescriber brick 5 | |

According to equation [7], the split-factors are calculated-as follows:

$$\begin{matrix}d . {,}_{{}_{1}} = \frac{14 , 000}{18 , 150} = 0.771 & [ e16 ] \\ d . {,}_{{}_{2}} = \frac{3 , 000}{18 , 150} = 0.165 & [ e17 ] \\ d . {,}_{{}_{3}} = \frac{800}{18 , 150} = 0.044 & [ e18 ] \\ d . {,}_{{}_{4}} = \frac{300}{18 , 150} = 0.017 & [ e19 ] \\ d . {,}_{{}_{5}} = \frac{50}{18 , 150} = 0.003 & [ e20 ]\end{matrix}$$

To avoid unreasonable large arrays of split-factors having negligible values resulting from equation [5], the split-factor array may be truncated as follows: The d_{.,j} numbers are sorted in descending order. A cutoff is applied when

$$\begin{matrix}{\sum }_{1}^{v} d . , j \leq δ , where v \leq w and \\ {\sum }_{1}^{v + 1} d . , j \leq δ ,\end{matrix}$$

Following this step, the original d_{.,j} are re-based according to

$$d . , j = \frac{d . {,}_{j}}{{\sum }_{1}^{v} d . {,}_{j}} \qquad [ 8 ]$$

in which equation [8] fulfills

$${\sum }_{1}^{v} d . , i = 1.$$

Hence, by multiplying the projected OTX sample data 38 in each pharmacy brick with the split-factors obtained in equation [8], a data record is generated for each 1,860-prescriber brick. This step combines the projected near-census GKV prescription data 26 concerning the distribution of data with the volume information derived from the projected OTX sample data 38.

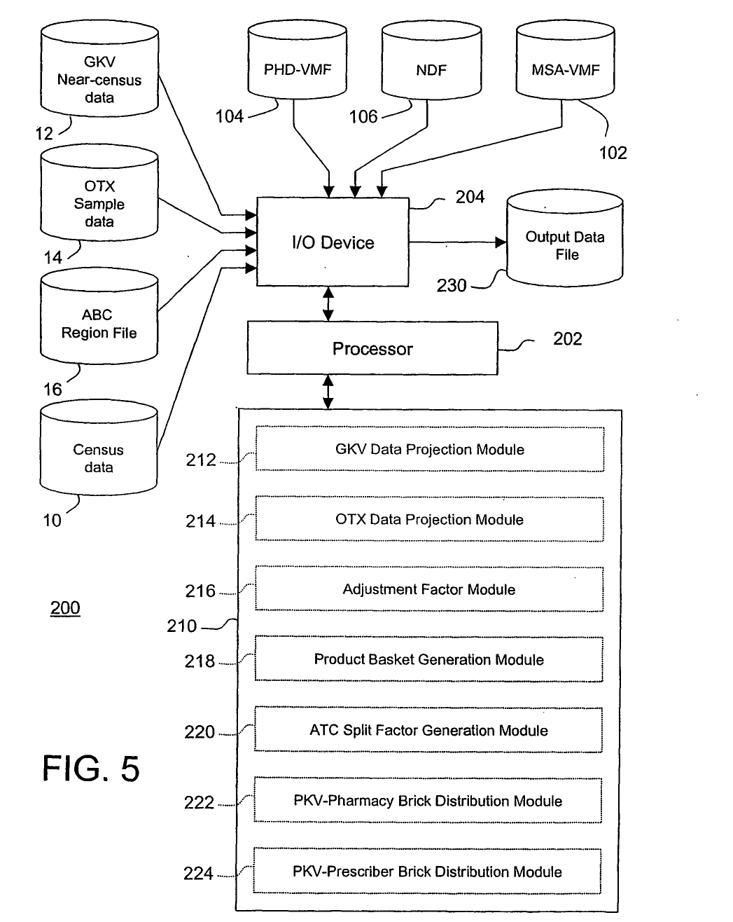

An exemplary system 200 in accordance with the invention is illustrated in FIG. 5. A computer processor 202 is used to control the input of data with the Input/Output device 204, to perform the processing steps described above, and to control the output of data with the Input/Output device 204. In the exemplary embodiment, the computer processor is an IBM mainframe computer model 9672-R66. Many alternative computers may be used that provide the same performance as the IBM 9672-R66.

The Census data 10 and GKV near-census data 12 are accessed from data suppliers by such modes as ISDN dial-in with connection protocol IDTRANS, ISDN dial-in with connection protocol FTP, internet with connection protocol FTP, or by courier service. Input and bridging software is used to import the data into the system 200. The OTX sample data 14 is accessed from the data supplier by the mailing of data disks or by electronic data transmission via the internet or IDSN dial in. Input software is used for file retrieval, data inflow monitoring, process/bridging/quality control, and address management to import the data into the system 200.

After being imported from data suppliers. the input data is stored in several files, as described above. For example, Census data 10, GKV near-census data 12, OTX sample data 14, ABC region file 16, MSA-VMF data 102, PHD-VMF data 104, and NDF data 106 are stored on hard disks. Hard disk storage may be, for example, IBM RAMAC Virtual Array Storage. Backup copies of the data may be stored on tape cartridges. IBM tape cartridge type 3490 may be used to store backup copies. Alternative hard disks and tape cartridges, well-known in the art, may also be used. The Input/Output device 204 may be a hard disk drive, or alternatively a tape drive, as is known in the art.

The software 210 is loaded onto the computer processor 202 to perform the processing steps. In the exemplary embodiment, the software is programmed in SAS. An OTX data projection module 212 contains software which programs the processor 202 to project sampled product sales to purchasers to obtain projected sampled product sales as described above in step 20 and equation [1]. A GKV projection module 214 contains software which programs the processor 202 to project the GKV near-census data for product sales to purchasers in the second category to obtain projected GKV near-census data for product sales to purchasers in the second category. GKV projection module 214, as described above in step 24 applies, for each geographical segment, a second proportional factor to the near-census data of product sales to purchasers in the second category as described in equation [2], and aggregates the projected GKV near-census data for each geographical segment to the respective geographical region.

The adjustment factor module 216 contains software which programs the processor 202 to adjust the projected sampled product sales calculated in module 214 by applying an adjustment factor to the projected product sales to purchasers in the first category. The adjustment factor is calculated as described above with respect to step 28 and equation [3].

The product basket generation module 218 contains software which programs the processor 202 to create the product basket file as described above with respect to step 110. The ATC split-factor generation module 220 contains software to program the processor 202 to calculate the ATC split factors, for each product type and for each geographical segment, a proportion of product sales to pharmacies in the geographical segment with the total product sales in the respective geographical region based on the census data of product sales. The ATC split factor calculation is described above is steps 118-124, and equation [5]. The PKV-Pharmacy Brick distribution module 222 applies the ATC split factors calculated in module 220 to distribute sales to purchasers on PKV prescriptions by pharmacy brick.

The PKV-Prescriber Brick distribution Module 224 contains software which programs the processor 202 to distribute sales to purchasers on PKV prescriptions by prescriber brick by applying second split-factors to the estimated product sales to purchasers on PKV prescriptions allocated by pharmacy brick, as described above in steps 40-50. The second split-factors, as detailed above in equations [7]-[8], for each pharmacy brick, represents a proportion of a total number transactions in each prescriber brick with a total number of transactions in the respective brick based on the projected near-census data of product sales to purchasers determined by the GKV Data projection module 214.

One skilled in the art will appreciate that the present invention can be practiced in fields other than pharmaceutical and by other than the described embodiments, which are presented here for the purposes of illustration and not of limitation, and the present invention is limited only by the claims that follow.

We claim:

1. A system for estimating product sales to purchasers in a first category allocated into a plurality of geographical segments based on service provider location, wherein a plurality of said geographical segments constitute a geographical region, the system comprising:
(a) a mass storage device for storing
(i) census data of one or more product sales to one or more data generating sales outlets, comprising one or more census data records including product type information and geographical segment information corresponding to a data generating sales outlet location,
(ii) near-census data of one or more product sales in a second category to one or more purchasers, comprising one or more near-census data records including product type information, geographical segment information corresponding to a data generating sales outlet location, and geographical segment information corresponding to a service provider location, and
(iii) sampled data of one or more product sales to one or more data generating sales outlets and to one or more purchasers, comprising one or more sample data records including product type information, location information of a data generating sales outlet location, and geographical region information corresponding to a data generating sales outlet location;
(b) an input/output device, coupled to the mass storage device, for receiving the census data, the near-census data, and the sampled data;
(c) a computer processor coupled to the inputloutput device and configured to
(i) for each geographical region, project sampled product sales to purchasers to obtain projected sampled product sales;
(ii) for each geographical region, project near-census data for product sales to purchasers in the second category to obtain projected near-census data for product sales to purchasers in the second category, and aggregate the projected near-census data for each geographical segment to the respective geographical region;
(iii) for each geographical region, adjust the projected sampled product sales to purchasers in the first category, based on a ratio of the projected sampled product sales to purchasers in the second category and the projected near-census data for product sales to purchasers in the second category, to obtain adjusted sampled product sales to purchasers in the first category;
(iv) distribute product sales to purchasers in the first category by geographical segment of the data generating sales outlet location, by applying first split factors to the adjusted product sales to purchasers in the first category to obtain estimated product sales to purchasers in the first category allocated by geographical segment of data generating sales outlet location, the first split-factors comprising, for each product type and for each geographical segment, a proportion of product sales to data generating sales outlets in the geographical segment with the total product sales in the respective geographical region; and
(v) distribute product sales to purchasers in the first category by the geographical segment of service provider location by applying second split-factors to the estimated product sales to purchasers in the first category allocated by geographical segment of data generating sales outlet location, the second split-factors comprising, for each geographical segment of data generating sales outlet location, a proportion of a total number transactions in each geographical segment of service provider location with a total number of transactions in the respective geographical segment based on the projected near-census data of product sales to purchasers in the second category.

2. The system of claim 1, wherein the computer processor is configured to project sampled product sales by applying a first proportional factor to the sampled data, which first proportional factor comprises, for each geographical region, a ratio of census product sales to sampled product sales.

3. The system of claim 1, wherein the computer processor is configured to project the near-census data of product sales to purchasers in the second category, by applying, for each geographical segment, a second proportional factor to the near-census data of product sales to purchasers in the second category which second proportional factor comprises, for each geographical segment, a ratio of a total number of data generating sales outlets in the census data to a total number of data generating sales outlets in the near-census data:

4. The system of claim 1, wherein the computer processor is configured to adjust the projected sampled product sales to purchasers in the first category by applying an adjustment factor which comprises a ratio of the projected sampled product sales to purchasers in the second category and the projected near-census data for product sales to purchasers in the second category.

5. The system of claim 1, wherein the input/output device is configured to output a data file containing estimated product sales to purchasers in the first category allocated by a geographical segment of a service provider location.

6. The system of claim 1, wherein the product sales are pharmaceutical product sales, the service provider is a physician, and the data generating sales outlet is a retail pharmacy.

7. The system of claim 6, wherein the product sales in the first category are pharmaceutical product sales on prescriptions covered by a private health insurance program, and the product sales in the second category are pharmaceutical product sales on prescriptions covered by a public health insurance program.

8. A method for estimating product sales to purchasers in a first category allocated into a plurality of geographical segments based on service provider location, wherein a plurality of said geographical segments constitute a geographical region, comprising the steps of:
(a) receiving census data of one or more product sales to one or more data generating sales outlets, the census data comprising one or more census data records including product type information and geographical segment information corresponding to a data generating sales outlet location;
(b) receiving near-census data of one or more product sales in a second category, the near-census data comprising one or more near-census data records including product type information, geographical segment information corresponding to a data generating sales outlet location, and geographical segment information corresponding to a service provider location;
(c) receiving sampled data of one or more product sales to one or more data generating sales outlets and to one or more purchasers, the sampled data comprising one or more sample data records including product type information and location information of a data generating sales outlet, and allocating each sampled data record to the respective geographical region corresponding to the location of the data generating sales outlet;
(d) for each geographical region, projecting sampled product sales to purchasers received in step (c) to obtain projected sampled product sales by applying a first proportional factor to the sampled product sales;
(e) for each geographical region, projecting near-census data for product sales to purchasers in the second category to obtain projected near-census data for product sales to purchasers in the second category by applying, for each geographical segment, a second proportional factor to the near-census data of product sales to purchasers in the second category received at step (b), and by aggregating the projected near-census data for each geographical segment to the respective geographical region;
(f) for each geographical region, adjusting the projected sampled product sales to purchasers in the second category by applying an adjustment factor to the projected product sales to purchasers in the first category determined in step (d), the adjustment factor comprising a ratio of the projected product sales to purchasers in the second category determined in step (d) and the projected near-census data for product sales to purchasers in the second category determined in step (e);
(g) distributing product sales to purchasers in the second category by geographical segment of the data generating sales outlet location by applying first split-factors to the adjusted product sales to purchasers in the first category determined in step (f), the first split-factors comprising, for each product type and for each geographical segment, a proportion of product sales to data generating sales outlets in the geographical segment with the total product sales in the respective geographical region based on the census data of product sales received in step (a); and
(h) distributing product sales to purchasers in the first category by the geographical segment of service provider location by applying second split-factors to the estimated product sales to purchasers in the first category allocated by geographical segment of data generating sales outlet location, the second split-factors comprising, for each geographical segment of data generating sales outlet location, a proportion of a total number transactions in each geographical segment of service provider location with a total number of transactions in the respective geographical segment based on the projected near-census data of product sales to purchasers in the second category determined in step (e).

9. The method of claim 8, wherein the step of projecting sampled product sales to purchasers comprises determining the first proportional factor, for each geographical region, a ratio of the census product sales received in step (a) to the sampled product sales received in step (c).

10. The method of claim 8, wherein the step of projecting near-census data for product sales to purchasers in the second category comprises determining the second proportional factor, for each geographical segment, a ratio of a total number of data generating sales outlets received in step (a) to a total number of data generating sales outlets received in step (b).

11. The method of claim 8, wherein the geographical segments comprises 1,860 bricks and the geographical regions comprise 66 regions.

12. The method of claim 8, wherein the step (g) of estimating product sales to purchasers in the first category allocated by geographical segment of the data generating sales outlet location comprises assigning, for each product type, an ATC4 classification.

13. A method for estimating pharmaceutical product sales to patients covered by a first insurance program allocated into a plurality of geographical segments based on prescriber location, wherein a plurality of said geographical segments constitute a geographical region, comprising the steps of:
(a) receiving census data of one or more pharmaceutical product sales, the census data comprising one or more census data records including product type information and geographical segment information corresponding to a respective pharmacy location;
(b) receiving near-census data of one or more pharmaceutical product sales to one or more patients covered by a second insurance program, the near-census data comprising one or more near-census data records including product type information, geographical segment information corresponding to a respective pharmacy location, and geographical segment corresponding to a respective prescriber location;
(c) receiving sampled data of one or more pharmaceutical product sales, the sampled data comprising one or more sampled data records including product type information and pharmacy location information, and allocating each sampled data record to a respective geographical region corresponding to the pharmacy location;
(d) for each geographical region, determining projected pharmaceutical product sales to patients by applying a first proportional factor to the sampled pharmaceutical product sales to patients sampled in step (c), the first proportional factor comprising, for the geographical region, a ratio of the census pharmaceutical product sales collected in step (a) to the sampled pharmaceutical product sales sampled in step (c);
(e) for each geographical region, determining projected near-census data for pharmaceutical product sales to patients covered by the second insurance program by applying, for each geographical segment, a second proportional factor to the near-census data of pharmaceutical product sales to patients covered by the second insurance program collected at step (b), the second proportional factor comprising, for each geographical segment, a ratio of a total number of dispensing pharmacies collected in step (a) to a total number of dispensing pharmacies collected in step (b), and by aggregating the projected near-census data for each geographical segment to the respective geographical region;
(f) for each geographical region, determining adjusted pharmaceutical product sales to patients covered by the first insurance program by applying an adjustment factor to the projected pharmaceutical product sales to patients covered by the first insurance program determined in step (d), the adjustment factor comprising a ratio of the projected pharmaceutical product sales to patients covered by the second insurance program determined in step (d) and the projected near-census data for pharmaceutical product sales to patients covered by the second insurance program determined in step (e);
(g) estimating pharmaceutical product sales to patients covered by the first insurance program allocated by geographical segment of the pharmacy location by applying first split-factors to the adjusted pharmaceutical product sales to patients covered by the first insurance program determined in step (f), the first split-factors comprising, for each product type and for each geographical segment, a proportion of pharmaceutical product sales to pharmacies in the geographical segment with the total pharmaceutical product sales in the respective geographical region based on the census data of pharmaceutical sales collected in step; and
(h) estimating pharmaceutical product sales to patients covered by the first insurance program allocated by the geographical segment of prescriber location by applying second split-factors to the estimated pharmaceutical product sales to patients covered by the first insurance program allocated by geographical segment of pharmacy location, the second split-factors comprising, for each geographical segment of pharmacy location, a proportion of a total number prescriptions in each geographical segment of prescriber location with a total number of prescriptions in the respective geographical segment based on the projected near-census data of pharmaceutical product sales to patients covered by the second insurance program determined in step (e).

14. The method of claim 6, further comprising creating a product basket file, for each product type, which includes information concerning the relative proportion of direct pharmaceutical product sales from manufacturers to pharmacies based on the census data collected in step (a).

15. The method of claim 7, further comprising excluding product types having a proportion of direct sales above a predetermined percentage.

16. The method of claim 6, wherein the information about product type comprises an ATC4 classification.

17. The method of claim 6, wherein the step (g) of estimating pharmaceutical product sales to patients covered by the first insurance program allocated by geographical segment of the pharmacy location comprises creating combinations for each geographical segment and product type.

18. The method of claim 10, wherein the step (g) of estimating pharmaceutical product sales to patients covered by the first insurance program comprises, calculating an array of the first split factors.

19. The method of claim 11, further comprising, after calculating the array of the first split factors, truncating the array for each first split factor below a predetermined minimum value and recalculating the array of the first split factors based on the remaining split factors.
